(19) United States
(12) Patent Application Publication
(10) Pub. No.: US 2025/0385016 A1
(43) Pub. Date: Dec. 18, 2025

(54) Method for and Means of Improving Irradiance Uniformity on ICF Targets in Conjunction with Nonlinear Optical Pulse Compression

(71) Applicants: Richard B. Holmes, Shingle Springs, CA (US); Robert O. Hunter, JR., Aspen, CO (US)

(72) Inventors: Richard B. Holmes, Shingle Springs, CA (US); Robert O. Hunter, JR., Aspen, CO (US)

(21) Appl. No.: 18/747,249

(22) Filed: Jun. 18, 2024

(51) Int. Cl. G21B 1/23; G21B 1/03

(52) U.S. Cl. CPC G21B 1/23; G21B 1/03

(57) ABSTRACT

A method for and a means of improving spatial intensity uniformity on target for a laser inertial confinement fusion (ICF) system, including a seed laser and a pump laser in a nonlinear optical amplifier, which is based on a near-backward Stimulated Brillouin scattering (SBS) nonlinear optical process. The spatial phase and amplitude profiles of the seed laser are adjusted to compensate for spatial nonuniformities in the pump laser in order to achieve a spatial intensity uniformity of the amplified seed laser on target of 2% or better.

### CROSS-REFERENCE TO RELATED APPLICATION

The present application claims priority to provisional patent application No. 63/522,966 filed on Jun. 23, 2023, the entire contents of which are incorporated herein by reference.

### BACKGROUND

Laser Inertial Confinement Fusion (ICF) requires a pulsed laser with at least 1 MJ of laser energy per pulse, and which has a spatial intensity uniformity on target which is ideally of the order of 2% or better. Higher levels of laser spatial non-uniformity can be tolerated if targets are surrounded by relatively large hohlraums which allow the x-rays caused by the laser to re-distribute spatially around the target. See A. W. Kritcher et al., “Design of inertial fusion implosions reaching the burning plasma regime,” Nature Phys., Vol. 18, pp. 251-258 (2022). Higher levels of laser spatial non-uniformity can also be tolerated if the target surface absorption is adjusted, or if the internal structure promotes rapid re-distribution of the x-rays caused by the laser. See R. O. Hunter, E. W. Cornell,

“Propellant Grading for Laser-Driven Multi-Shell Inertial Confinement Fusion Target,” U.S. patent Ser. No. 11/488,729, issued on 1 Nov. 2022. However, with an ICF laser beam design involving adjustable seed laser phase and amplitude, it is desirable to directly improve the uniformity of the irradiance profile as well.

The problem is addressed today at the one existing laser ICF facility that has sufficient energy for fusion, the U. S. Lawrence Livermore National Laboratory. The problem is addressed by balancing the energy of the 192 laser beams, through cross-beam energy transfer (CBET); multiple laser wavelengths to smooth laser speckle and support CBET; and an improved hohlraum geometry. See A. L. Kritcher et. al., “Design of inertial fusion implosions reaching the burning plasma regime,” Nature Phys., Vol. 18, pp. 251-258 (2022). Also, reduced “coast times” resulting from alternative target designs can reduce time-dependent nonuniformities. “These designs varied the relative laser powers and energies to control the symmetry with intentional energy transfer between the laser beams.” on page 3 of the above reference. However, this approach was less successful because of the different optical architecture and target design. In the approach herein, adjustment of seed beams in a nonlinear optical amplifier with some repeatability of the pump profile will allow adjustment of the seed output energy to improve uniformity of energy on target. Also, with some degree of gain saturation in the amplifier, as is the case with backward or near backward SBS amplifiers, there is less sensitivity to the seed input energy. In the case in which beams do not overlap, the possibility of CBET can be avoided and this allows independent control of energy in each beamlet spot on target. The use of independent steering mirrors for each spot allows for correction of limited variation of object position as well as object orientation to hit laser entrance holes (LEHs) of limited size.

In the context of R. O. Hunter, “Integration of direct compressor with primary laser source and fast compressor,” U.S. patent Ser. No. 10/862,260, issued on 8 Dec. 2020; a nonlinear optical near-backward SBS process can both compress a laser pulse in time and redirect the high-intensity compressed pulse to a very good focus on a target. See J. R. Murray, J. Goldhar, D. Eimerl, A. Szoke, “Raman Pulse

Compression of Excimer Lasers for Applications to Laser Fusion,” IEEE Jour. Quant. Electron., Vol. QE-15 pp. 342-367 (1979). However, the approach discussed in this article will produce only a single good focus on target which is therefore highly non-uniform. This high degree of non-uniformity is not desirable for laser ICF, because a spatially-uniform implosion is needed. To address this, the seed laser can have a pre-set spatial profile of intensity and phase that distributes the intensity more uniformly over the surface of the ICF target or within the hohlraum surrounding the target. The objective of this more uniform laser profile is to impose a more uniform distribution of x-rays that will implode the target fuel in a very uniform manner.

One spatially uniform x-ray profile is a flat-top profile on a spherical target. This can be achieved by a laser profile that also has a angularly uniform irradiance on the target (for direct drive targets). See J. Lindl, Development of the indirect-drive approach to inertial confinement fusion and the target physics basis for ignition and gain,” Phys. Plasmas, Vol. 2, pp. 3933-4024 (1995). However, this distribution is technically difficult to achieve to an accuracy of 1%.

To overcome this, an indirect-drive target which is a spherical target surrounded by a hohlraum that is typically cylindrical is often chosen, as discussed in the immediately preceding reference. In such a configuration, the laser energy is incident on the inner wall of a hohlraum consisting of a material with high atomic number Z, Z>48, which then converts the laser energy to x-rays which then re-distribute as they surround the target to a more uniform configuration. This indirect-drive configuration has several disadvantages. First, the hohlraum volume typically is considerably larger in volume than the target, and this reduces the x-ray intensity on the target. Second, the hohlraum is typically open and this allows loss of x-rays and also causes a non-isotropic distribution of x-rays on the target, with a lower flux of x-rays in the direction of the hohlraum openings, which are known as Laser Entrance Holes (LEHs). See W. Kritcher et al., “Design of inertial fusion implosions reaching the burning plasma regime,” Nature Phys., Vol. 18, pp. 251-258 (2022).

To further overcome these latter drawbacks of the state-of-the-art indirect-drive targets that are currently in use, one may design a hohlraum that is spherical and closely conforms to the spherical target inside. This addresses the problem of large relative volume of the hohlraum compared to the target. Then the LEH's must be made relatively small and distributed relatively uniformly over the exterior of this conformal hohlraum in order to achieve uniformity. Such LEH's are also relatively small to reduce the loss of x-rays. Such evenly-spaced and small holes then must be uniformly irradiated by an array of laser beam spots, or if non-uniformly irradiated, the target internal structure must be designed to smooth out such non-uniformity. The objective of the approach documented in this patent is to provide a method for and means of irradiation to these small holes that are as uniform as possible.

A second objective of the approach documented in this patent is to tolerate a moving and rotating target, as may occur when the targets are frequently inserted into the laser line-of-sight. In such cases, the laser must hit an LEH pattern that is both translating and rotating with prespecified limits.

### SUMMARY

The preferred embodiment described herein consists of separating the large-area laser beam into smaller subapertures which are then separately focused to one or more Laser Entrance Holes (LEH's) on the target. The smaller subaperture beamlets may be adjusted in amplitude to account for intensity non-uniformities in the pump beam. The smaller subaperture beamlets may also be steered independently to direct the beamlets to the location of the LEH's on the target structure to ensure that the maximum laser energy enters the LEHs and not the neighboring case of the target, even in the presence of limited amounts of target motion and rotation.

### BRIEF DESCRIPTION OF THE DRAWINGS

FIG. 1 shows a means for an improved irradiance uniformity configuration.

FIG. 2 shows various spatial irradiance patterns that can be applied at the target using phase plates or steered subapertures applied to the low power seed laser.

FIG. 3 shows a means for an improved irradiance uniformity configuration wherein each module is about 25×25 cm in cross sectional area in each module.

FIG. 4 shows a means for an improved irradiance uniformity configuration wherein each module is about 5×5 cm in cross sectional area in each module.

FIG. 5A shows an example of a preferred seed intensity apodization profiles of 5×5 cm modules in a 25×25 cm region, with no pre-compensation of beamlet power.

FIG. 5B shows an example of normalized spot energies, with a 7.1% standard deviation, on target.

FIG. 6A shows an example of a preferred seed intensity apodization profiles of 5×5 cm modules in a 25×25 cm region, with pre-compensation of beamlet power.

FIG. 6B shows an example normalized spot energies, with a 2.1% standard deviation, on target.

FIG. 7 shows a schematic example of the benefit of averaging in near-backward SBS for improved uniformity of energy in spots on target.

### SPECIFICATION

For our purposes, the term “approximately”, “about”, “near”, “roughly” refer to a given value ranging plus/minus 20%. For example, the phrase of “approximately 1 atmosphere” is intended to encompass a range of 0.80 to 1.20 atmospheres.

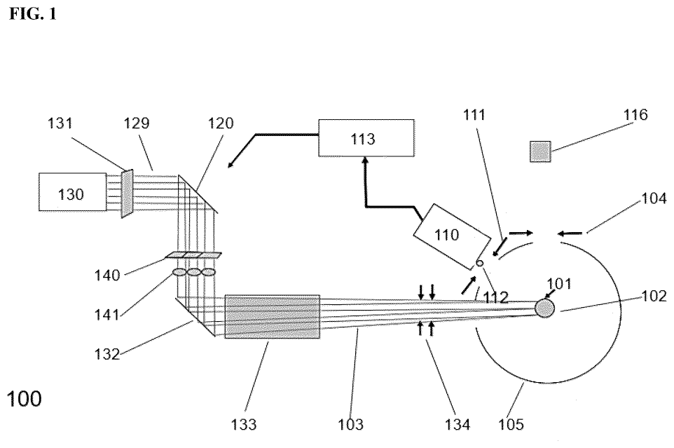

Referring to FIG. 1, the means for and method of improved irradiance uniformity. The improved irradiance uniformity system 100 aims an amplified seed laser beam 103 at a target 101 which should nominally arrive at aimpoint 102 at the same time as the amplified seed laser beam 103. In the preferred embodiment, the target is dropped through open shutters 104 into the detonation chamber 105 from a target launch mechanism 116. As the target approaches the aimpoint 102, a wide-field-of-view (WFOV) sensor 110 looks through open shutters 111 at the location of the target to identify the target's position and orientation. Since the detonation chamber 105 is nominally dark as the target falls in, light may be provided by an LED light source 112 so that the WFOV sensor 110 has adequate signal-to-noise ratio (SNR). At least one frame of target imagery is collected during a period of about 1 msec or less. This imagery data is then processed by a fast processor 113 to produce an estimated target location and orientation at the time of arrival of the amplified seed laser beam 103. This information is converted into angular offsets at the location of a fast-steering mirror(s) (FSM) 120. A low-power seed laser beam 129 is emitted by a seed laser 130. The seed laser 130 creates the seed laser beam 129 at the appropriate frequency, polarization, and time. As an example, the low-power seed laser beam 129 may have a pulse energy of about 1000 J at a wavelength of about 248 nm with a pulse repetition about once every 10 seconds. The seed laser beam 129 is then formed into beamlets using spatial amplitude control means 131 and reflects off the FSM or FSMs 120 and is then focused by optional phase plates 140 or focusing lens or lenses 141, which focusses the light onto the target. The seed laser light then reflects off a blast mirror 132 which functions to protect the low-power optics from the fusion blast. The blast mirror also serves as a turning optic to direct the low-energy seed light toward the target. The seed laser light then passes through a gain region 133 which amplifies the seed laser pulse to the energy and intensity needed to effect fusion. In the preferred embodiment, the gain region 133 comprises either N₂ or one of several noble gases and the gain is a result of a nonlinear optical interaction known as stimulated Brillouin scattering (SBS). Stimulated Raman Scattering (SRS) may also be used. The amplified seed laser beam(s) 103 then proceeds toward the target, passing through the open laser shutter or shutters 134. The timing and pointing of the seed laser is such that it arrives at the target plane at the same time as the target arrives. One or more laser entrance holes (LEHs) are irradiated by the laser and effect fusion.

In addition to the nominal specifications shown above, it is highly desirable to close the shutters 104 of the target injection region so that target blast does not heat the targets in the target cue, which are kept at a nominal temperature of roughly 20 K. Further, shutter 111 of the WFOV sensor 110 so that the sensor is not blinded and possibly incinerated by the target blast. Also, the laser shutters 134 are highly desirable to separate the target region which is nominally at vacuum conditions of about 10⁻³ or less of atmospheric pressure from the gain region which is nominally at a pressure of 1 atmosphere.

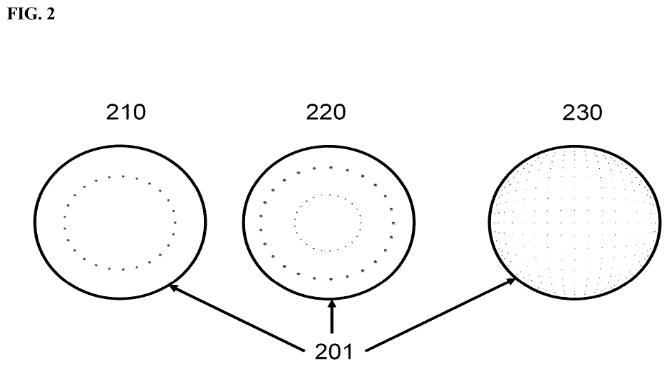

The seed laser beam 129 has a cross-sectional area of about 0.75 meters wide by 1 meter high in a preferred embodiment. The seed beam spatial profile is broken up into “modules,” which are nominally square regions in the transverse dimension of the seed beam that will be separated adjusted for phase magnitude. Each module may be spatially smoothed at their perimeter by a spatial apodizer 131. These modules are depicted as separate regions in the array of fast-steering mirrors (FSMs) 120, in the array of phase plates 140, and in the array of lenses 141. These fast-steering mirrors and lenses direct and focus the respective seed light onto the target. The phase plates are used to create a spatial pattern in each module that is advantageous for laser ICF. Several patterns that are advantageous for ICF are shown in FIG. 2. One preferred embodiment of target LEH patterns in a conformal spherical hohlraum, 210, has a ring of spots with a radius that is a substantial fraction of the radius of the target silhouette 201. The phase plates in each module then forms a pattern of a ring of spots or a pattern of a subset of the spots in the ring, by applying a phase pattern to the portion of seed laser light that passes through that specific module. In a second preferred target embodiment, 220, two or more rings of spots are formed by the phase plates. In a third target embodiment, 230, the spots are nearly equally spaced over the hemisphere of the target, with some spots missing near the edge of the silhouette 201 to avoid grazing-angle incidence. Small spots are preferred for several reasons. First, small spots lead to small LEH's, which limits the loss of energy for the conformal spherical hohlraum. Second, spots that are nearly diffraction limited cannot have significant pattern variations within the spots, so this leads to more uniform energy deposition after conversion to x-rays and the associated spatial smoothing that occurs.

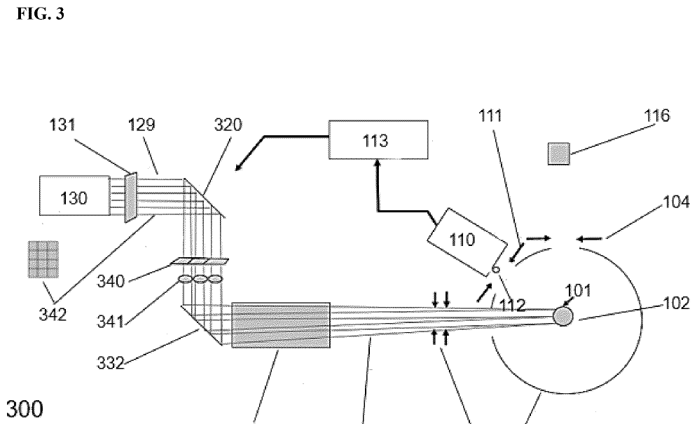

In one preferred embodiment 300 shown in FIG. 3, the modules 342 are each approximately 25×25 cm in cross-sectional area and each has a static phase plate that adjusts the seed beams ray directions so that the seed beam will fall onto the target in a pre-determined pattern. There is an array of 3×4 such modules in this embodiment, so that the array of FSMs 320, the array of phase plates 340, and the array of lenses 341 are 3×4 arrays fitting into a nominal 0.75×1.0-meter cross-sectional area. As mentioned in the prior paragraph, this pre-determined pattern could be any one of a variety of patterns such as: a uniform intensity pattern on the target silhouette, or any one of the varieties shown in FIG. 2 such as: a ring of spots 210, a series of rings of spots 220, or a spot array 230. The required phase pattern can be computed by the Gerchberg Saxton algorithm, for example. This embodiment with 25×25 cm modules is capable of producing spots on target with a full-width at half maximum (FWHM) as small as about λ*L/D. Here λ is the seed laser wavelength, L is the distance to the target, and D is the module width. For a wavelength lambda of 248.5 nm, a focal length L of 30 meters, and a module width D of 25 cm, the nominal spot FWHM is about 30 microns. This embodiment has the advantages of small spots and common aberrations during propagation to the target, but it has the disadvantages that the phase plate will produce scattered energy due to both construction and design, and that the spots within a module cannot be independently steered to accurately point to separate LEHs at a rotating target. The phase plate produces scattered energy by design because a phase-only modulation usually cannot always exactly match exactly a given far-field pattern; some amplitude modulation is also usually needed. But amplitude modulation is more difficult at high pulse energy and typically involves throwing away light energy.

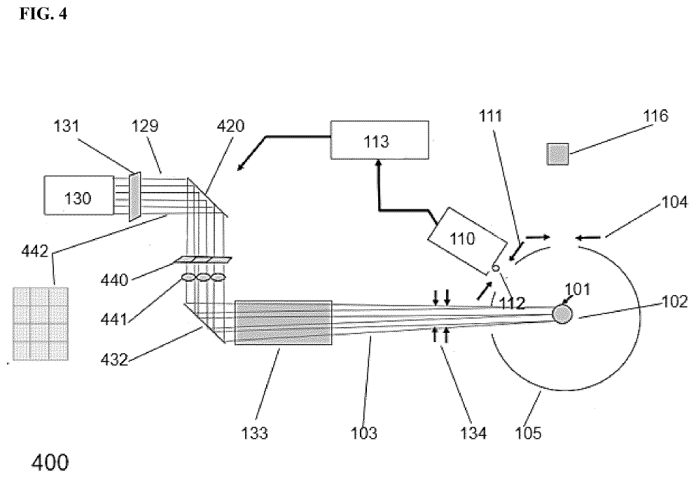

In a second preferred embodiment, FIG. 4, each module is about 5×5 cm in cross sectional area as shown by array 442. There are 15×20 such modules in a nominal 0.75×1.0-meter cross-sectional area of the seed laser beam 129. Each is steered in real time to a separate spot using a separate FSM 420 and focused using a separate focusing lens or focusing mirror 441. There need not be a phase plate for each module in this embodiment. This embodiment has the disadvantage that the diffraction-limited spots are larger (about 150 microns FWHM). However, this approach has the advantage that each module can be steered accurately to separate LEHs on a rotating target, which is a very important advantage. Another advantage is that costly phase plates are not needed. Another advantage of this approach is that if there are refractive index variations on the path to the target, the 5-cm wide aperture is relatively less susceptible to such aberrations than a 25-cm wide aperture. Another advantage of this approach is that the 5-cm optics are typically significantly less costly than the optics for a 25-cm-width module for the same tiled area of 25×25 cm. Yet another advantage of this approach compared to the first preferred embodiment is that there is significantly less scattered light from the phase plates so that more energy goes into the LEHs. Yet another advantage of this embodiment is that the energy in each seed module amplitude and phase can be independently controlled to compensate for non-uniformities among spots that are repeatable from pulse to pulse.

Common to both embodiments above is the advantage that multiple independent modules can send light to the same LEH if desired, potentially resulting in averaging that can improve uniformity. Another potential advantage for both of the two embodiments is the potential benefit of separated beamlets going to separated spots in the vicinity of the target. This can reduce crossbeam energy transfer due to plasma SRS near the target, which typically degrades uniformity. Yet another advantage common to both embodiments is that the LEHs may be relatively small to avoid lost energy.

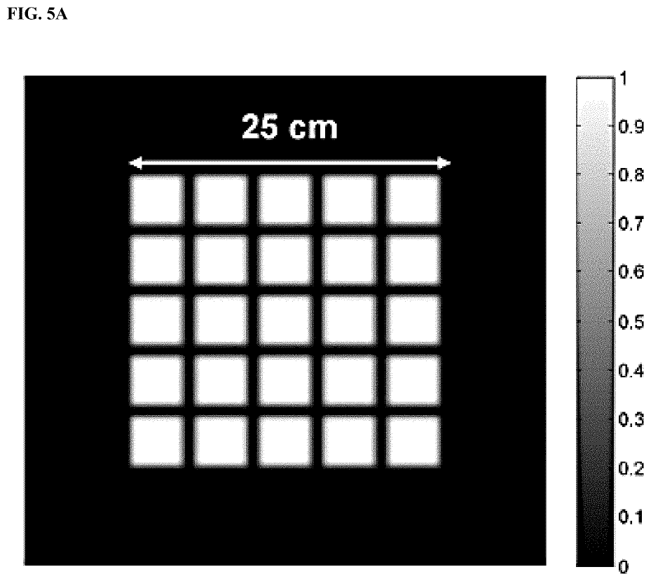

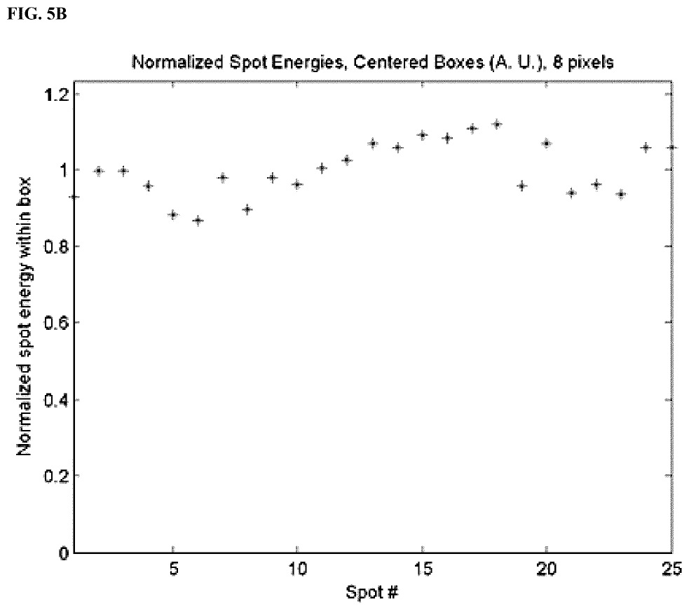

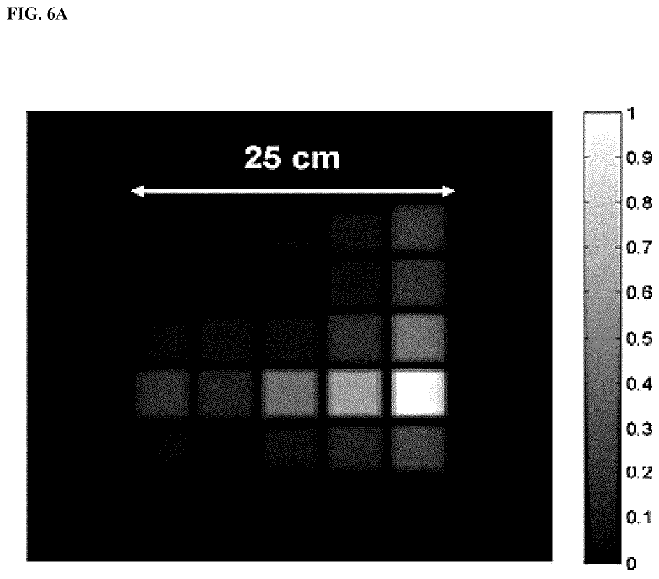

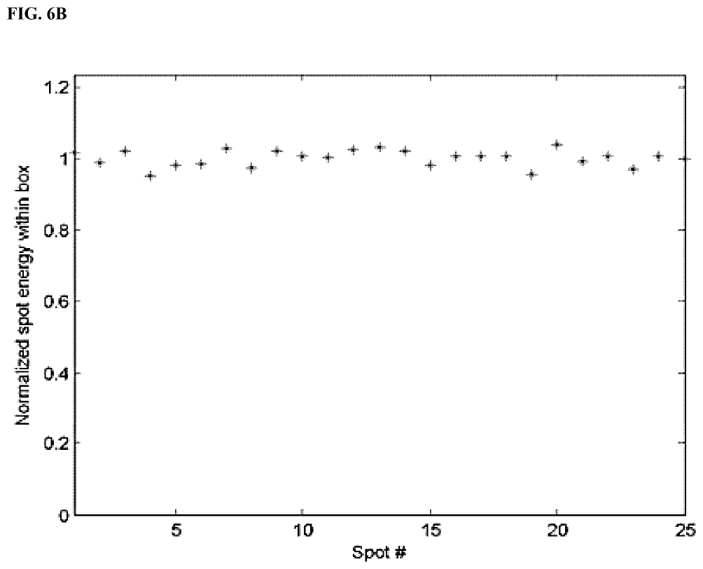

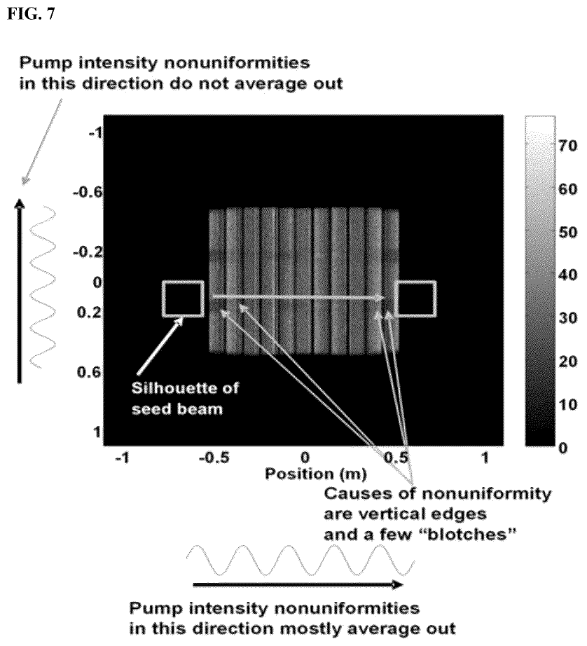

In addition, for both embodiments there is a benefit of control of each beam overall amplitude and amplitude profile. Control of the beam modules amplitude profile (apodization), performed by apodizer 131 ensures good overlap between the seed and pump beams but avoids excess diffraction. An apodization function that has been found to be useful in simulations is a 10^{th}-order super-gaussian as shown in FIG. 5A. Amplitude modulation, i.e., modulation of the power and energy in each subaperture, can aid in improving uniformity of energy into LEHs at the target as mentioned above and as shown in FIG. 6A. Amplitude modulation is most beneficially performed by spatial redistribution of energy rather than spatial reduction and loss of energy. FIG. 5B shows the spot-to-spot nonuniformity that arises because of non-uniformities in the gain medium, from a detailed nonlinear wave-optics simulation. In this case there is 7.1% spot-to-spot energy nonuniformity (standard deviation). FIG. 6B shows the benefits of subaperture amplitude modulation, in which there is only 2.1% standard deviation of spot energy. Both embodiments benefit from the use of the near-backward geometry with Stimulated Brillouin Scattering (SBS) for the gain medium in the gain region 133, because of averaging of pump laser non-uniformities in one direction as shown in FIG. 7. The pump laser will have some nonuniformity as shown in FIG. 7 due to prior amplifications in the prior nonlinear pulse compression and amplification processes. Both embodiments benefit from the gain saturation that occurs with backward or near-backward SBS, which reduces sensitivity to the input seed fluence. This latter benefit implies that the input seed does not need to be set precisely to achieve a desired outcome, but it also has the disadvantage that a large seed intensity dynamic range may be needed to achieve a given level of spot uniformity on target. If the seed intensity or fluence are too high, it can exceed the damage threshold for optical components. An SBS embodiment is also preferred because it leaves little residual energy in the gain medium and such media typically have high laser breakdown threshold energies. In such an embodiment, the seed laser beam 129 is incident on the pump laser beam at an angle θ from the counter-propagating direction. The angle θ is approximately 10 degrees in a preferred embodiment.

The specifications displayed and described herein are examples only, and not intended to limit the general principles of the invention. Certain features discussed as part of separate embodiments may be combined into a single embodiment. Additionally, embodiments may make use of various features known in the art but not specified explicitly in this application.

Embodiments can be scaled-up and scaled-down in size, and relative proportions of components within embodiments can be changed as well. The range of values of any parameter (e.g., size, thickness, density, mass, etc.) of any component of an embodiment of this invention, or of entire embodiments, spanned by the exemplary embodiments in this application should not be construed as a limit on the maximum or minimum value of that parameter for other embodiments, unless specifically described as such.

1. In a system for improved irradiance uniformity on an Inertial Confinement Fusion (ICF) Target, comprising:
an ICF target;
a detonation chamber;
a seed laser beam source;
a spatial modulation mechanism to control the phase and amplitude of the seed laser beam;
a steering mechanism to control movement of the seed laser beam, wherein the steering mechanism comprises one or more fast steering mirrors; and
a gain medium to amplify the seed laser beam.

2. The system of claim 1, further comprising:
wherein the spatial modulation mechanism comprises a phase plate located between the seed laser beam source and the steering mechanism, and wherein the phase plate creates a distinct pre-determined spatial pattern on the ICF target.

3. The system of claim 2, further comprising:
wherein the distinct spatial pattern created by the phase plate forms one or more ring-spot patterns.

4. The system of claim 3, further comprising:
wherein the distinct spatial pattern created by the phase plate forms a plurality of distinct and separated beams.

5. The system of claim 4, further comprising:
wherein the phase plate is a dynamic phase plate to controllably adjust the seed laser beams into any unique but pre-determined pattern.

6. The system of claim 1, further comprising:
wherein the spatial modulation mechanism individually adjusts the magnitude of distinct regions of a distinct pre-determined spatial pattern within the seed laser beam to improve intensity uniformity on the ICF target.

7. The system of claim 6, further comprising:
wherein the spatial modulation mechanism individually adjusts the magnitude of the distinct regions by a spatial redistribution of the energy of the seed laser beam without substantial loss in overall energy.

8. The system of claim 6, further comprising:
a gain region located between the steering mechanism and the detonation chamber, wherein the gain region receives the seed laser beam from a turning optic before amplifying and projecting through to the detonation chamber.

9. The system of claim 2, further comprising:
wherein the spatial modulation mechanism directs each of the plurality of distinct pre-determined spatial patterns to separate locations in the vicinity of the ICF target.

10. The system of claim 2, further comprising:
wherein the spatial modulation mechanism directs each of the plurality of distinct pre-determined spatial patterns to the same location of the ICF target.

11. In a method for improving irradiance uniformity on an Inertial Confinement Fusion (ICF) Target, comprising:
launching an ICF target into a detonation chamber;
directing a seed laser beam towards a rotationally moving ICF target;
controlling a phase and amplitude of the seed laser beam with a spatial modulation mechanism;
a steering mechanism to controlling a movement of the seed laser beam with a steering mechanism, wherein the steering mechanism comprises one or more fast steering mirrors; and
amplifying the seed laser beam in a gain medium.

12. The method of claim 11, further comprising:
creating a distinct pre-determined spatial pattern on the ICF target by placing a phase plate between the seed laser beam source and the steering mechanism.

13. The method of claim 12, further comprising:
creating one or more ring-spot patterns by the phase plate.

14. The method of claim 13, further comprising:
forming a plurality of distinct and separated beams.

15. The method of claim 14, further comprising:
controlling and adjusting the seed laser beam into any unique but predetermined pattern.

16. The method of claim 15, further comprising:
individually adjusting the magnitude of distinct regions of a distinct pre-determined spatial pattern within the seed laser beam to improve intensity uniformity on the ICF target.

17. The method of claim 16, further comprising:
individually adjusting the magnitude of the distinct regions by a spatial redistribution of the energy of the seed laser beam without substantial loss in overall energy.

18. The method of claim 16, further comprising:
receiving the seed laser beam into a gain region from a turning optic before amplifying and projecting through to the detonation chamber.

19. The method of claim 12, further comprising:
directing each of the plurality of distinct pre-determined spatial patterns to different locations in the vicinity of the ICF target.

20. The method of claim 12, further comprising:
directing each of the plurality of distinct pre-determined spatial patterns to the same location of the ICF target.
